(19) United States
(12) Patent Application Publication
(10) Pub. No.: US 2024/0121657 A1
(43) Pub. Date: Apr. 11, 2024

(54) METHOD AND APPARATUS FOR COMMUNICATING SECURE INFORMATION

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA)

(21) Appl. No.: 18/529,784

(22) Filed: Dec. 5, 2023

Related U.S. Application Data
(63) Continuation of application No. PCT/CN2021/105628, filed on Jul. 10, 2021.

(51) Int. Cl. H04W 28/02; H04W 8/22; H04W 24/10

(52) U.S. Cl. CPC H04W 28/0268; H04W 8/22; H04W 24/10; H04W 28/0273

(57) ABSTRACT

Some embodiments of the present disclosure provide for secure information transfer from apparatus to network device. The network device may define and configure a secure transfer path, having functions of secure data transmission with or without QoS. A new entity plane may take one or more new radio network temporary identifiers for flexible transmission scheduling. The network device may initiate the secure information transfer for downlink or uplink transmissions. The apparatus may initiate the secure information transfer for uplink transmissions.

### CROSS-REFERENCE TO RELATED APPLICATIONS

This application is a continuation of International Application No. PCT/CN2021/105628, filed on Jul. 10, 2021, application of which is hereby incorporated by reference in its entirety.

### TECHNICAL FIELD

The present disclosure relates generally to wireless communication and, in particular embodiments, to a method and apparatus for communicating secure information.

### BACKGROUND

In a future wireless network, certain information oriented to user equipment (UE) and certain information oriented to privacy (e.g., accurate UE positioning, UE sensing information, artificial intelligence information) may be considered to be sensitive. However, such information may also be considered to be key to a base station (BS) for effective control and optimization of communication between the BS and the UE. This may be especially true for some time-sensitive or time-critical information, such as accurate UE position information. However, in current networks, the above-referenced sensitive information, such as UE positioning information, is not accessible by the BS or is transparent to the BS, in that the BS may be configured to simply relay or bypass a message including such sensitive information as sent by the UE.

### SUMMARY

Some embodiments of the present disclosure provide for secure information transfer from user equipment to base station. The base station may define and configure a secure transfer path (or paths) for uplink and/or downlink, having functions of secure data transmission with or without QoS. A new entity plane may take one or more new radio network temporary identifiers for flexible transmission scheduling. The base station may initiate the secure information transfer for uplink and/or downlink transmissions. The user device may initiate the secure information transfer for uplink transmissions or receive the secure information from downlink.

User equipment routinely collect and transmit information. Unfortunately, much of the information passes through the base station on the way to a core network or location management function in a manner that is transparent to the base station. The base station may benefit from receiving certain information from the user equipment (and detecting the information), where there is an interest, on the part of the user equipment, for keeping the information secure.

A new secure information transmission, of secure user equipment information, may be originated from a base station. The base station may define and configure a new secure transfer path (or paths). Accordingly, the secure information transmission may be controlled by the base station over the user plane, where the secure user equipment information transmission may be considered as “special data traffic.”

According to an aspect of the present disclosure, there is provided a method of communicating information. The method includes receiving, by an apparatus from a network device, one or more configuration, the one or more configuration comprises: at least one traffic quality of service (QoS) characteristic defined by the network device; at least one parameter associated with information transfer for an uplink (UL) path and a downlink (DL) path between the apparatus and the network device, and securing information. The method further includes transmitting information, using the UL path, by the apparatus to the network device or receiving information, using the DL path, by the apparatus from the network, wherein the information is secured based on the securing information. A network device can be a RAN (radio access network) node, a BS, another BS-like node such as a drone, a satellite; or alternatively, these terms are interchangeable for use in the following paragraphs.

According to another aspect of the present disclosure, there is provided an apparatus. The apparatus includes a memory storing instructions and a processor. The processor is caused, by executing the instructions, to receive, from a network device, one or more configuration, the one or more configuration including: at least one traffic Quality of Service (QoS) characteristic defined by the network device; at least one parameter associated with information transfer for an UL path and a DL path between the apparatus and the network device; and securing information. The processor is further caused, by executing the instructions, to transmit information, using the UL path, by the apparatus to the network device or receiving information, using the DL path, by the apparatus from the network, wherein the information is secured based on the securing information.

According to a further aspect of the present disclosure, there is provided a method of communicating information. The method includes transmitting, by a network device to an apparatus, one or more configuration, the one or more configuration comprises: at least one traffic Quality of Service (QoS) characteristic defined by the network device; at least one parameter associating with information transfer for an UL path and a DL path between the apparatus and the network device; and securing information. The method further includes receiving information using the UL path, by the network device from the apparatus, or transmitting information using the DL path, by the network device to the apparatus, wherein the information is secured based on the securing information.

According to a still further aspect of the present disclosure, there is provided a network device. The network device includes a memory storing instructions and a processor. The processor is caused, by executing the instructions, to transmit, to an apparatus, one or more configuration, the one or more configuration comprises: at least one traffic Quality of Service (QoS) characteristic defined by the network device; at least one parameter associating with information transfer for an UL path and a DL path between the apparatus and the network device; and securing information. The processor is further caused to receive information from the apparatus using the UL path or transmit information to the apparatus using the DL path, wherein the information is secured based on the securing information.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a user equipment and a base station with a secure uplink path passing through respective protocol sublayers, in accordance with aspects of the present application;

FIG. 7 illustrates an uplink QoS traffic flow mapping configuration, in accordance with aspects of the present application;

FIG. 8 illustrates a new Service Data Adaptation Protocol (SDAP) message carrying positioning information, in accordance with aspects of the present application;

FIG. 9 illustrates a new SDAP message similar to the new SDAP message of FIG. 8, in accordance with aspects of the present application;

FIG. 10 illustrates a user equipment and a base station with a secure downlink path passing through respective protocol sublayers, in accordance with aspects of the present application;

FIG. 11 illustrates an uplink QoS traffic flow mapping configuration, in accordance with aspects of the present application;

FIG. 12 illustrates a new SDAP message similar to the new SDAP message of FIG. 8, in accordance with aspects of the present application;

FIG. 13 illustrates a new SDAP message similar to the new SDAP message of FIG. 8, in accordance with aspects of the present application;

FIG. 14 illustrates, in a signal flow diagram, an exchange of messages between the base station and the user equipment, in the case of the base station initiating dynamic scheduling for a secure information transmission, in accordance with aspects of the present application;

FIG. 15 illustrates, in a signal flow diagram, an exchange of messages between the base station and the user equipment, in the case of the user equipment initiating dynamic scheduling for a secure information transmission, in accordance with aspects of the present application;

FIG. 16 illustrates, in a signal flow diagram, an exchange of messages between the base station and the user equipment ahead of the exchanges represented in FIG. 14 and FIG. 15, in accordance with aspects of the present application;

FIG. 17 illustrates a new SDAP message carrying secure information, in accordance with aspects of the present application;

FIG. 18 illustrates a new SDAP message carrying secure information, in accordance with aspects of the present application;

FIG. 19 illustrates an uplink QoS traffic flow mapping configuration, in accordance with aspects of the present application;

FIG. 20 illustrates a new SDAP message carrying secure information, in accordance with aspects of the present application;

FIG. 21 illustrates a new SDAP message carrying secure information, in accordance with aspects of the present application;

FIG. 22 illustrates a downlink QoS traffic flow mapping configuration, in accordance with aspects of the present application;

FIG. 23 illustrates a new radio resource control (RRC) message carrying service information, in accordance with aspects of the present application;

FIG. 24 illustrates a new RRC message carrying service information, in accordance with aspects of the present application;

FIG. 25 illustrates an uplink QoS traffic flow mapping configuration, in accordance with aspects of the present application;

FIG. 26 illustrates a user equipment and a base station with a secure uplink path passing through respective protocol sublayers, in accordance with aspects of the present application;

FIG. 27 illustrates a new RRC message carrying service information, in accordance with aspects of the present application;

FIG. 28 illustrates a new RRC message carrying service information, in accordance with aspects of the present application;

FIG. 29 illustrates a downlink QoS traffic flow mapping configuration, in accordance with aspects of the present application; and

FIG. 30 illustrates a user equipment and a base station with a secure downlink path passing through respective protocol sublayers, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

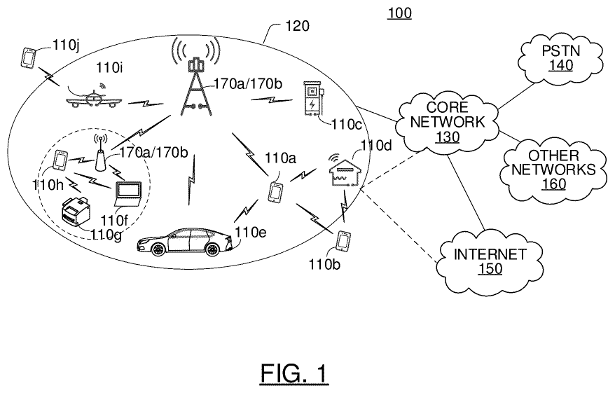

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

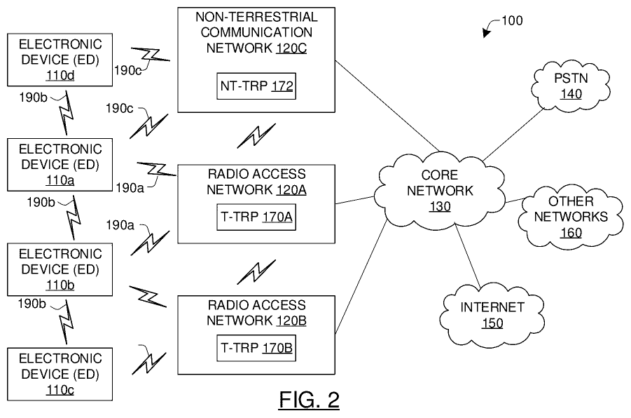

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

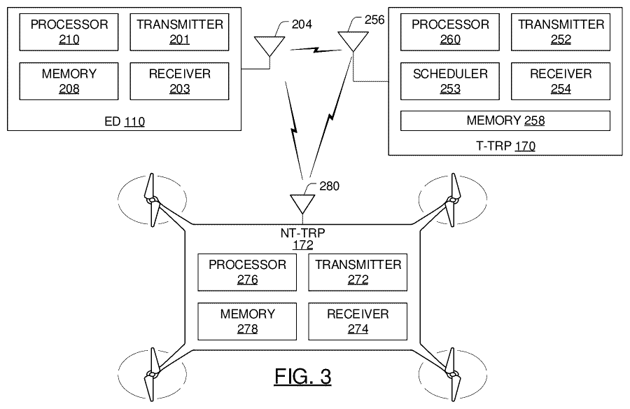

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

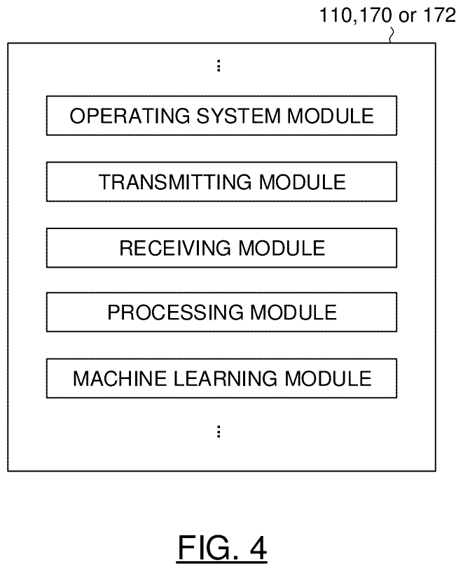

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and the slot length is 0.5 ms for 30 kHz subcarrier spacing. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling that may use a known downlink control information (DCI) format, or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

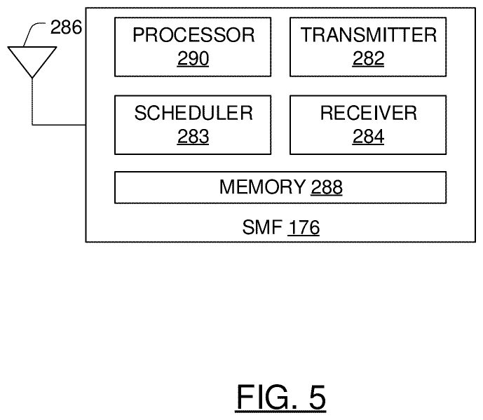

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

UE (ED) privacy information may include UE position information, artificial intelligence (AI) training inputs, AI training outputs, AI modelling parameters, etc. Some of the information may be measured, such as: round trip time (RTT); angle of departure (AOD); and time difference of arrival (TDOA). Some of the information may vary dynamically, e.g., measured positioning or sensing for a mobile UE, including UE location, UE speed, UE distance travelled and UE environment measurements.

Other information may be associated with relatively large amounts of data, e.g., AI modelling parameters and configurations, which may be considered to benefit from secure and effective transmissions, for example, for UE AI configuration. The UE privacy information all benefits from protection during the information transfer. It follows that anonymization and encryption procedures may be employed, especially with regard to an over-the-air interface between the UE and the BS. Moreover, this information may be associated with different QoS (quality of service) specifications, above and beyond privacy specifications, e.g., in terms of latency constraints. As a result, it can be seen that secure information transfer paths between UE and BS that can satisfy these constraints would be welcome.

In current wireless networks, NR positioning data transfer may be carried out via RRC signaling and Non-Access-Stratum (NAS) messages between location management function (LMF) and UE entities. The NR positioning information is encrypted and transmitted over a LTE Positioning Protocol (LPP) layer between the UE and the LMF in a secured way. However, from the perspective of the BS, the positioning information is only relayed by the BS. That is, the positioning traffic passes through the BS, without being accessible to the BS.

Current NR measurement and reporting mechanisms relate to transmitting non-sensitive information between the UE and the BS. Current NR measurement and reporting mechanisms include two types of measurement messages: layer 3 (L3) messages; and layer 1 (L1) messages. L3 messages (with filtered processing over measured parameters) may be transferred via RRC messaging in a semi-static manner, a periodic manner, an aperiodic manner or in an event-triggered manner, based on RRC configurations. A given RRC message may be transmitted through a control plane (CP) and is usually applicable to small traffic. L1 messages may be transferred over physical (PHY) sublayer messaging. Transmission of L1 messages may be dynamically scheduled but the transmission is not secured due to non-encryption in PHY sublayer. The L1 messages may include CSI reporting messages, such as: Channel Quality Indicator (CQ); precoding matrix indicator (PMI); rank indication (RI); and hybrid automatic repeat request (HARQ) feedback.

Another secure transfer path is to take user plane (UP) such as transmission of ultra-reliable low-latency communication (URLLC) or enhanced mobile broadband (eMBB) traffic, where a UE traffic session is set up and managed by an application in the core network (CN). In other words, this type of traffic is built between UE and application entities, where the BS is simply relaying the traffic from the UE towards the application. As a result, the BS is not able to access the details of the traffic context for applicable communication control and/or scheduling management.

Aspects of the present application relate to secure information transfer between UE and BS, considering possible QoS support for each type of UE information such as positioning-type information, sensing-type information or AI-type information.

Secure transfer paths between the UE and the BS for UE-sensitive information transmissions may include many characteristics.

According to one characteristic, the BS may originate, define and configure the user plane for secure transmission of UE-sensitive or private information, such as accurate positioning information, sensing information, or AI information.

The BS may define a protocol data unit (PDU) session for each UE information transfer. The defining may associate the PDU session with one or more traffic flows, with each traffic flow being associated with a same or different QoS characteristic. A first PDU session with a few QoS traffic flows may be mapped to a first data radio bearer (DRB). A second PDU session with other QoS traffic flows may be mapped to a second DRB, different from the first DRB. As a result, a single PDU session with traffic flows having different sets of QoS flows may be mapped to one or more DRBs. All DRBs related to the same PDU session have the same enable/disable setting for ciphering and the same enable/disable setting for integrity protection. Securing information, such as ciphering and integrity protection information, can be defined or configured to allow for generating secure information in one or more of a PDCH layer, a RLC layer, a MAC layer and a PHY layer. Securing information may also be defined for generating secure information in an RF chain or a specially encoded and encrypted context. An RF chain is a cascade of electronic components and sub-units. The electronic components and sub-units may include amplifiers, filters, mixers, attenuators and detectors. Usually, one communication system includes transmitting RF chains and receiving RF chains in addition to digital signal processing (i.e., baseband) components. A DRB may then be mapped to a dedicated traffic logical channel, where all logical channels are mapped to a downlink shared transport channel or an uplink shared transport channel, which are mapped to a corresponding physical downlink shared channel or physical uplink shared channel.

There are two protocol stacks: a user plane protocol stack; and a control plane protocol stack. There are three main types of data channels that are used within a given mobile network. Logical channels are one main type of data channels, where a given logical channel can be in one of two groups of logical channels: control logical channels; and traffic logical channels. The control logical channels are used for the transfer of data from the control plane and the traffic logical channels are used for the transfer of user plane data. Transport channels are another main type of data channels, where transport channels may perform multiplexing of the logical channel data to be transported by the physical layer(s). Physical (PHY) channels are a third main type of data channels, where the physical channels are those channels that are closest to the actual transmission of the data over the radio access network (RAN)/RF and the physical channels are used to carry the data over the radio interface.

Any DL path or UL path may involve at least one PHY channel, one transport channel and one logical channel, where the one logical channel is associated with a DRB with DRB identity or a SRB with SRB identity and, thus, any DL path or UL path may be used to transmit user data information as a user plane (using the user plane protocols) or may be used to transmit user control information as a control plane (using the control plane protocol). There is a logical and manageable flow of data from the higher levels of a given protocol stack down to the physical layer associated with a radio bearer (RB). From a radio bearer perspective, to setup a path in the user plane or control plane, a DRB is mapped to a dedicated traffic logical channel, all the logical channels are mapped to a downlink shared transport channel or an uplink shared transport channel, which shared transport channels are mapped to corresponding physical downlink shared channels or physical uplink shared channels, as appropriate; and an SRB is mapped to a dedicated control logical channel, all the logical channels are mapped to a downlink shared transport channel or an uplink shared transport channel, which shared transport channels are mapped to corresponding physical downlink shared channels or uplink shared channels, as appropriate. These mappings can be configured by RRC signaling.

The UE information can be divided between a sensitive category and a non-sensitive category. Usually, the information directly related to the UE itself could be considered to be sensitive information, such as the positioning of the UE, sensing information of the UE, AI modeling information, AI training information and AI outputs, etc. Other information that is not directly related to the UE itself could be considered to be non-sensitive information, such as signal strength, environment measurements, interference and/or channel measurements from the serving BS or from neighbor BSs.

The UE-sensitive information can be considered as “special data traffic,” which can be further divided into, e.g., different levels of privacy for the purposes of access, management or/and protection. For example, certain information may be considered to be UE-sensitive, but not directly related to communication control, and this information may not need to be accessible to the BS; whereas some UE-sensitive information that is beneficial to the communication control and management can be accessible to, managed by and controlled by the BS. The UE-sensitive information accessibility by the BS may be regulated and agreed among the UE, the BS and the core network before the information can be used.

The BS may use UE privacy information for communication optimization. Communication optimization may involve dynamic control, power control, resource allocation and/or scheduling management.

The BS may configure secure transfer paths through a combination of RRC and L1 signaling.

The secure transfer paths for DL and UL may have characteristics or attributes associated with securing information that may include UE traffic cyphering and integrity protection.

The paths may go through one or more protocol sublayers to include features of current sublayers, e.g., from the PHY sublayer up through the MAC sublayer, the RLC sublayer, the NR Packet Data Convergence Protocol (PDCP) sublayer to the NR Service Data Adaptation Protocol (SDAP) sublayer.

Secure data transmission may be configured in, for example, the NR PDCP sublayer. QoS differentiations may be configured in, for example, the NR SDAP sublayer. A specific QoS may be associated with each type of UE information. The different types of UE information may include the sensing information type, the positioning information type or the AI information type.

Future wireless networks may have different sublayer designs and terminology relative to current wireless networks. However, future wireless networks are expected to include security sublayers and may include QoS sublayers. For example, the securing information may include at least UE traffic cyphering and integrity protection information for generating secure information, which may be performed in one or more sublayers of PHY, MAC, RLC, PDCP, SDAP, etc., in future wireless networks. Securing information may also be defined for generating secure information in an RF chain or a specially encoded and encrypted context.

For the BS to be able to access the UE information, the BS may configure related UE measurement information, the reporting information (or one or more lists of the reporting information) and transmission formats for the information, where the information formats may be closely related to the UE information type that is to be measured and transferred.

Once one or more secure paths are configured by the BS, UE privacy or sensitive information may be transferred by way of: (1) BS-initiated DL and UL transmission, where, at the beginning, once a UE is connected to the network, the BS may perform RRC configuration on UE measurement and reporting and, upon demand for UE feedback information, or periodically (optionally associated with a timer), the BS may schedule resources for UL transmission and/or DL transmission of UE information, such as location, sensing data, AI data, etc., and the UE may (optionally) perform new measurements to, thereby, collect/prepare the UE information as a report; (2) UE-initiated UL transmission, where, at the beginning, once a UE is connected to the network, the BS may perform RRC configuration on UE measurement and reporting, once the UE is ready to provide feedback information to the BS (responsive to a triggering condition being satisfied, such as an event driven condition, a periodic condition, a timer running out condition, etc.), the UE may send a buffer status request (BSR) or a scheduling request (SR) to the BS and obtain a UL grant from the BS, such that, as a result, a BSR configuration or an SR configuration, such as PUCCH resources, may be provided ahead of time by the BS, for example, specific or dedicated resource configurations for BSR (in a MAC message) and specific or dedicated resource configurations for SR (in a PHY message) may be provided ahead of time by the BS; and (3) UE-initiated, grant-free (GF) UL transmission, where, at the beginning, once a UE is connected to the network, the BS may perform RRC configuration on UE measurement and reporting, as well as GF time and frequency resources and other related parameters of interest, such that, once UE is ready to provide feedback information to the BS (responsive to a triggering condition being satisfied, such as an event driven condition, a periodic condition, a timer running out condition, etc.), the UE may send the UE information as reporting to the BS in the GF time-frequency resources that have been (pre-)configured, where the GF time-frequency resources may or may not be dynamically activated (e.g., using DCI) by the BS before using the GF time-frequency resources.

Optionally, one or more new radio network temporary identifiers (RNTIs) may be used for flexible transmission scheduling. It may also be possible to use the preexisting cell-RNTI (C-RNTI) of the UE for transmission scheduling. A new DCI format or a modified DCI format may be defined for PDCCH monitoring and transmission scheduling to support secure information transfer.

Optionally, secure transfer paths without QoS can also be set up via control plane (CP), where RRC messages may carry secure UE information between the UE and the BS.

After the BS accesses UE-sensitive information for communication control and management, the BS may share the UE-sensitive information with valid (i.e., approved for secure information access) core network functions such as a LMF, a user plane function (UPF), an AI module or a third party service center. The connection path between the BS and the corresponding core network functions may go through the user plane, the control plane or a combination of the user plane and the control plane.

Aspects of the present application relate to the BS defining and configuring UL secure transfer paths with QoS capability between the UE and the BS.

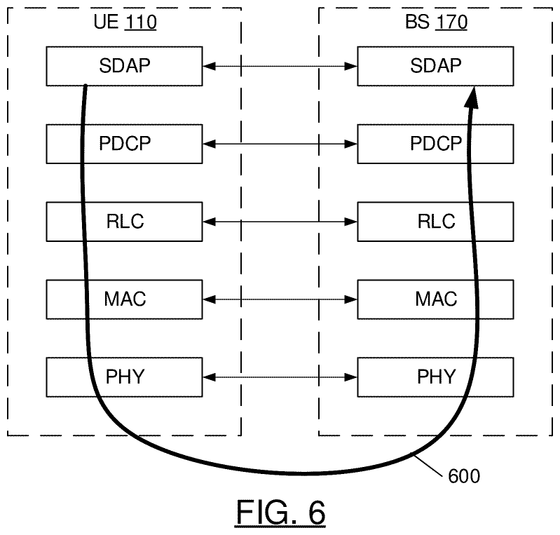

FIG. 6 illustrates communication between a UE 110 and a BS 170 over an air-link interface, also called a “Uu-link.” The UE 110 is illustrated as including many protocol sublayers defined for the over the air-link interface, identified as: SDAP; PDCP; RLC; MAC; and PHY. Similarly, the BS 170 is illustrated as including many protocol sublayers defined for the over the air-link interface, identified as: SDAP; PDCP; RLC; MAC; and PHY. A secure UL path 600 with QoS is illustrated traversing the protocol sublayers from the SDAP sublayer of the UE 110 to the SDAP sublayer of the BS 170.

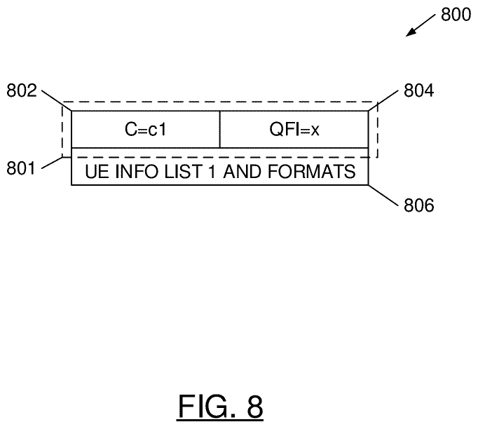

The BS may define QoS characteristics for a protocol data unit (PDU) session with one or more traffic flows or messages, wherein each traffic flow/message is associated with a QoS characteristic and the QoS characteristic may comprise one or more of a latency constraint, an information sensitivity indication, a minimum required data rate, a traffic priority, a traffic/information type, an information format, etc. For example, the BS may use a QoS flow identity (QFI), as shown in FIG. 8, to indicate a QoS characteristic for one or more traffic flows in a PDU session or to indicate a QoS characteristic for the UE information or message carrying out one or more traffic flows in the PDU session. The QoS characteristic may be associated with one UE information type and/or context. For example, one UE information type and/or context may be associated with a latency-critical QoS and another UE information type and/or context may be associated with a non-latency-critical QoS, where the QFI values for the latency-critical QoS and the non-latency-critical QoS are configured differently for different types/contexts of the UE information.

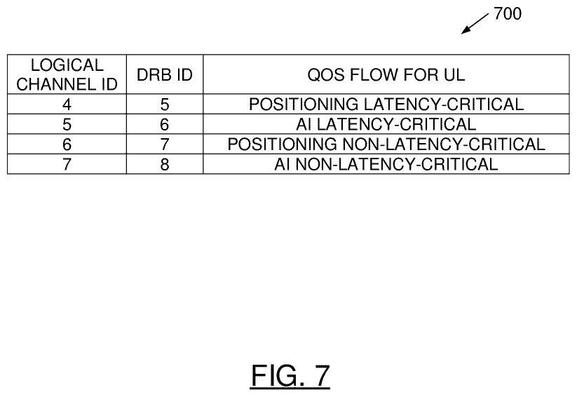

A UL QoS traffic flow mapping configuration 700 is illustrated in FIG. 7, where traffic flow(s) or the UE information type/context configured with a QFI for a UL path may be associated with dedicated radio bearer with a DRB identity and the DRB identity is mapped to a logical channel identity (LCID), where a different LCID may be associated with a different transmission priority that is associated with the UE information QoS. As a result, to configure and establish UL paths according to the UL QoS traffic flow mapping configuration 700 in FIG. 7: information/traffic flow with type and QoS indication as “positioning latency-critical” is associated with a DRB 1D of 5, which is configured and mapped to an LCID of 4; information/traffic flow with type and QoS indication as “AI latency-critical” is associated with a DRB ID of 6, which is configured and mapped to an LCID of 5; information/traffic flow with type and QoS indication as “positioning non-latency-critical” is associated with a DRB ID of 7, which is configured and mapped to an LCID of 6; and information/traffic flow with type and QoS indication as “AI non-latency-critical” is associated with a DRB ID of 8, which is configured and mapped to an LCID of 7. Note that DRB ID values and LCID values in FIG. 7 are only examples and other values can be applicable as well.

FIG. 8 illustrates that a new SDAP message 800 may include a header field C and a header field QFI and may carry the UE information such as latency-critical positioning information in a way defined or configured by UE INFO LIST 1 AND FORMATS, where the UE INFO LIST 1 AND FORMATS can be configured by RRC pre-configured or predefined. In current networks, an SDAP message has an SDAP header with a QFI field for traffic flow QoS identification. For future networks, a QFI field may be included in an SDAP-like sublayer. To support this SDAP-like sublayer, a SDAP message may include one or more new SDAP headers for the SDAP message QoS identity and/or SDAP message attribute or category indication.

The new SDAP message 800 of FIG. 8 includes an SDAP header 801. The SDAP header 801 includes a C field 802 for an SDAP message attribute or category. The SDAP message attribute or category may be defined in terms of, e.g., control/data traffic and/or an indication as to what UE information type (including, e.g., positioning information), what the UE information to be included and the information formats formulated for transmission. For example, the C field 802 of the new SDAP header 801 of FIG. 8 indicates that the SDAP message attribute or category is identified by a value, such as “c1,” indicative of UE accurate positioning information.

The new SDAP header 801 of FIG. 8 also includes a QFI field 804 for SDAP message/flow QoS indication. For example, the QFI field 804 of the new SDAP header 801 of FIG. 8 may carry a value, e.g., “x,” that specifies a latency-critical QoS. The QFI for a traffic flow may be configured to one value selected from among a set of pre-defined or pre-configured values representing different QoS differentiations and requirements in terms of latency, minimum data rate, maximum data rate, traffic priority, traffic/information type, information format, delivery source and target, and any combination of one or more of the above attributes or non-QoS attributes (i.e., no QoS is considered), etc., which are applied to all related figures and descriptions on QFI in this application.

The new SDAP message 800 of FIG. 8 includes an SDAP message body field 806. For example, the SDAP message body field 806 of the new SDAP message 800 of FIG. 8 includes the UE information based on configuration of UE info (list) and message organized format(s).

The UE info list and formats may be configured to determine what UE information is transmitted and how the UE information is organized for transmission in the SDAP message body field 806. The UE info list and formats may be configured by the BS 170 via RRC signaling and may be related to what the BS 170 instructs the UE 110 to measure or/and report. Note that the UE INFO LIST 1 and FORMATS 806 is not the SDAP message/UE information itself, rather a definition on what information is being included in the SDAP message and how the information is to be organized in the SDAP message, in this way, both the UE side and the BS side have an aligned view on the SDAP message processing. The UE INFO LIST may be related to what the BS 170 accesses for timely for communication control and management. Sensing information, positioning information or/and AI information may be categorized into different information sets and the information sets may be organized into UE INFO LISTS with certain formats as configured, where the information in a UE INFO LIST may be associated with a QoS indication, for example, a latency-critical information indication. In FIG. 8, the UE INFO LIST 1 and FORMATS may be, for example, configured by RRC signaling when one or more DRBs are configured and established for secure transfer UL paths, where UL flows with different QoS indications can be mapped to distinct dedicated radio bearers and to distinct MAC logical identities. In the UL QoS traffic flow mapping configuration 700 of FIG. 7, it is illustrated that different QoS traffic flows may map to different DRBs and there may be a DRB to MAC logical channel ID mapping.

Conveniently, the new SDAP message 800 of FIG. 8 may be used to transfer both time-sensitive and non-time-critical sensitive UE information. Additionally, the new SDAP message 800 of FIG. 8 may be used to transfer both small and large amounts of information.

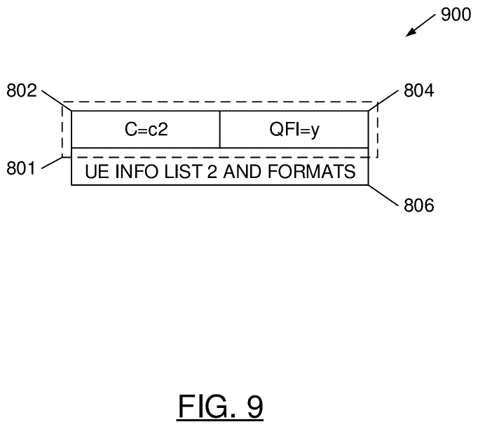

FIG. 9 illustrates a new SDAP message 900 similar to the new SDAP message 800 of FIG. 8. The C field 802 in the SDAP header 801 of the new SDAP message 900 of FIG. 9 indicates that the SDAP message attribute or category is identified by a value, such as “c2,” indicative of UE positioning information (and/or a static or slow moving status). The QFI field 804 of the new SDAP header 801 of the new SDAP message 900 of FIG. 9 may carry a value, e.g., “y,” that specifies non-time-critical QoS. The SDAP message body field 806 of the new SDAP message 900 of FIG. 9 includes UE INFO LIST 2 and FORMATS. The UE INFO LIST 2 and FORMATS may be, for example, for non-latency-critical information. Furthermore, the UE INFO LIST 2 and FORMATS may be, for example, configured by RRC signaling.

In the example shown in FIG. 6, UE positioning information originating at the UE 110 end may be carried, over the secure UL path 600, in an SDAP message (see the example SDAP message 800 of FIG. 8) using transmission formats as configured in the SDAP message body field 806 and with the SDAP header 801 having corresponding values in the C field 802 and in the QFI field 804, as configured.

The SDAP message may be encrypted in the PDCP sublayer and may pass through processing in the RLC sublayer, the MAC sublayer and the PHY sublayer to, thereby, form transmitted signals at the UE 110 end of an over-the-air link to the BS 170 end.

The signals received at the BS 170 may go through inverse signal processing from the PHY sublayer up to the SDAP sublayer so that the BS 170 may obtain the positioning information. The positioning information may be used, by the BS 170, for communication control and management, including (dynamic) beam switching and management and optimized scheduling.

Note that, though the secure UL path 600 may be configured, with parameters provided by the BS 170, for secure information transmission by the UE 110, it is also possible that the secure UL path 600 may be used for transmission of non-sensitive information. The SDAP message format and the QoS configurations may be established by RRC signaling in a control plane via SRB first; then, an SDAP message, to be organized in a form configured by the RRC, may be transferred in a user plane or via DRB, where UE secure information is transmitted. Moreover, the RRC signaling may comprise configurations of one or more of the following: traffic QoS for the information (to be transmitted as SDAP message); DRB identity; logical channel identity associated with DRB identity; and securing information, such as UE traffic cyphering and integrity protection in one or more of PDCP, RLC, MAC, PHY sublayers in future networks.

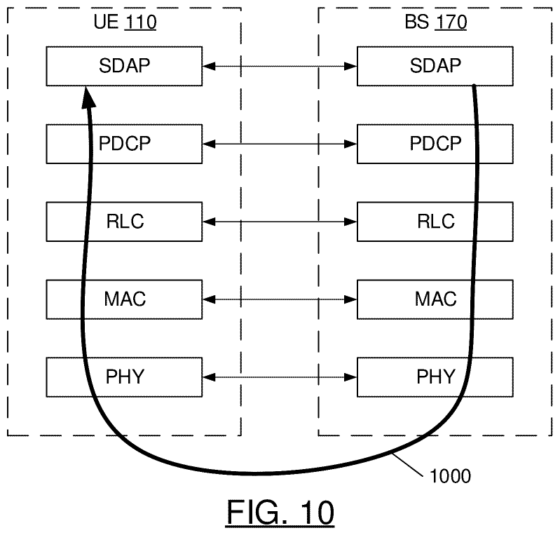

In a manner similar to FIG. 6, FIG. 10 illustrates the UE 110 and the BS 170 but establishes a secure DL path 1000 for the secure information (e.g., AI information or model parameters) transmission from the BS 170 to the UE 110 over an air-link interface or a Uu-link. The UE 110 is illustrated as including many protocol sublayers defined for the over the air-link interface, identified as: SDAP; PDCP; RLC; MAC; and PHY. Similarly, the BS 170 is illustrated as including many protocol sublayers defined for the over the air-link interface, identified as: SDAP; PDCP; RLC; MAC; and PHY. The secure DL path 1000 with QoS is illustrated traversing the protocol sublayers from the SDAP sublayer of the BS 170 to the SDAP sublayer of the UE 110.

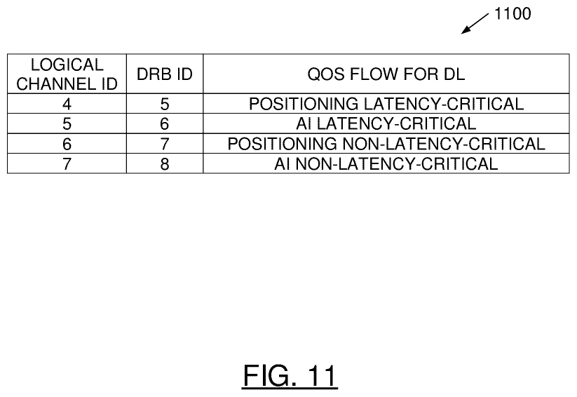

A DL QoS traffic flow mapping configuration 1100 is illustrated in FIG. 11, where traffic flow(s) or the UE information type/context configured with an QFI for a DL path may be associated with dedicated radio bearer with a DRB identity and the DRB identity is mapped to a LCID, where a different LCID may be associated with a different transmission priority that is associated with the UE information QoS. As a result, to configure and establish DL paths according to the DL QoS traffic flow mapping configuration 1100 in FIG. 11: information/traffic flow with type and QoS indication as “positioning latency-critical” is associated with a DRB ID of 5, which is configured and mapped to an LCID of 4; information/traffic flow with type and QoS indication as “AI latency-critical” is associated with a DRB ID of 6, which is configured and mapped to an LCID of 5; information/traffic flow with type and QoS indication as “positioning non-latency-critical” is associated with a DRB ID of 7, which is configured and mapped to an LCID of 6; and information/traffic flow with type and QoS indication as “AI non-latency-critical” is associated with a DRB ID of 8, which is configured and mapped to an LCID of 7. Note that DRB ID values and LCID values in FIG. 11 are only examples and other values can be applicable as well.

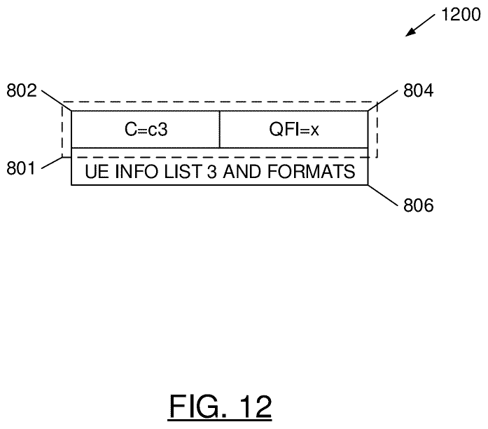

FIG. 12 illustrates a new SDAP message 1200 similar to the new SDAP message 800 of FIG. 8. The new SDAP message 1200 may carry the UE information such as non-latency-critical positioning information in a way defined or configured by UE INFO LIST 3 AND FORMATS, where the UE INFO LIST 3 AND FORMATS can be configured by RRC pre-configured or predefined. The C field 802 in the SDAP header 801 of the new SDAP message 1200 of FIG. 12 indicates that the SDAP message attribute or category is identified by a value such as “c3” as AI data information. The QFI field 804 of the new SDAP header 801 of the new SDAP message 1200 of FIG. 12 may carry a value, e.g., “x,” that specifies latency-critical QoS. The SDAP message body field 806 of the new SDAP message 1200 of FIG. 12 includes UE INFO LIST 3 and FORMATS. The UE INFO LIST 3 and formats may be, for example, for latency-non-critical information. Furthermore, the UE INFO LIST 3 and FORMATS may be, for example, configured by RRC signaling.

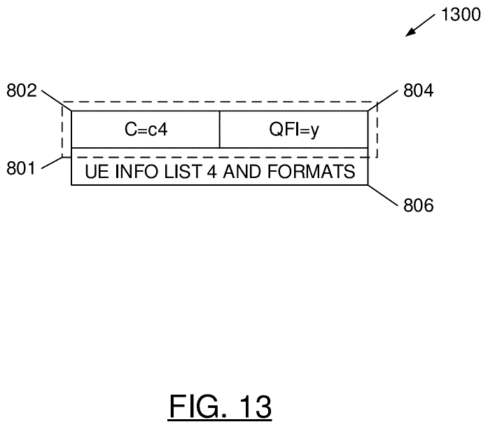

FIG. 13 illustrates a new SDAP message 1300 similar to the new SDAP message 800 of FIG. 8. The new SDAP message 1300 may carry the UE information such as non-latency-critical positioning information in a way defined or configured by UE INFO LIST 4 AND FORMATS, where the UE INFO LIST 4 AND FORMATS can be configured by RRC pre-configured or predefined. The C field 802 in the SDAP header 801 of the new SDAP message 1300 of FIG. 13 indicates that the SDAP message attribute or category is identified by a value such as “c4” as AI data information (and optionally non-latency-critical attribute). The QFI field 804 of the new SDAP header 801 of the new SDAP message 1300 of FIG. 13 may carry a value of, e.g., “y,” that specifies a non-latency critical QoS. The SDAP message body field 806 of the new SDAP message 1300 of FIG. 13 includes UE INFO LIST 4 and formats. The UE INFO LIST 4 and formats may be, for example, for latency-critical information. Furthermore, the UE INFO LIST 4 and formats may be, for example, configured by RRC signaling.

The UE INFO LIST and FORMATS may be, for example, configured by RRC signaling on a DRB for secure transfer DL paths, where DL flows with different QoS indications can be mapped to dedicated radio bearers and to MAC logical identities. In the DL QoS traffic flow mapping configuration 1100 of FIG. 11, it is illustrated that different QoS traffic flows may map to different DRBs and there may be a DRB to MAC logical channel mapping.

Conveniently, the new SDAP message 800 of FIG. 8 may be used to transfer both time-sensitive and non-time-critical sensitive UE information. Additionally, the new SDAP message 800 of FIG. 8 may be used to transfer both small and large amounts of information.

In the example shown in FIG. 10, AI (modeling) information originating at the BS 170 end may be carried, over the secure DL path 1000, in an SDAP message (see the example SDAP message 800 of FIG. 8) using transmission formats as configured in the SDAP message body field 806 and with the SDAP header 801 having corresponding values in the C field 802 and in the QFI field 804, as configured.

The SDAP message may be encrypted in the PDCP sublayer and may pass through processing in the RLC sublayer, the MAC sublayer and the PHY sublayer to, thereby, form transmitted signals at the BS 170 end of an over-the-air link to the UE 110 end.

The signals received at the UE 110 may go through inverse signal processing from the PHY sublayer up to the SDAP sublayer so that the UE 110 may obtain the AI (modeling) information.

The AI (modeling) information may be used, by the UE 110, for communication control and management, including (dynamic) AI modeling parameter updating and management, and optimized training.

Note that, though the secure DL path 1000 may be configured, with parameters established at the BS 170, for secure information transmission by the BS 170, it is also possible that the secure DL path 1000 may also be used for transmission of non-sensitive information. The SDAP message format and the QoS configurations may be established by RRC signaling in a control plane via SRB first; then, an SDAP message, to be organized in a form configured by the RRC, may be transferred in a user plane or via DRB, where UE secure information is transmitted. Moreover, the RRC signaling may comprise configurations of one or more of the following: traffic QoS for the information (to be transmitted as SDAP message); DRB identity; logical channel identity associated with DRB identity; and securing information, such as UE traffic cyphering and integrity protection in one or more of PDCP, RLC, MAC, PHY sublayers in future networks.

Given that secure transfer paths have been configured for UL (see the secure UL path 600 of FIG. 6) and/or DL (see the secure DL path 1000 of FIG. 10), the BS 170 may dynamically schedule information transmissions via one or more of the configured secure paths. For example, the BS 170 may dynamically schedule positioning information transmissions, sensing information transmissions, AI information transmissions, etc.

The UE information transfer may be performed in one of at least two ways: the BS 170 may initiate dynamic scheduling for a UE information transmission; or the UE information transfer may be initiated by the UE 110 requesting an information transmission.

In the case of the BS 170 initiating dynamic scheduling for a UE information transmission, the information transmission may be an UL transmission or a DL transmission.

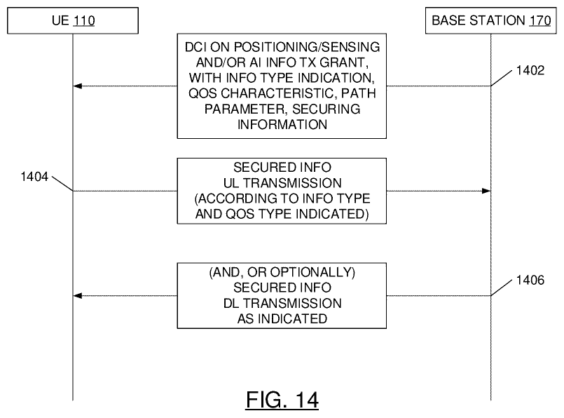

FIG. 14 illustrates, in a signal flow diagram, an exchange of messages between the BS 170 and the UE 110, in the case of the BS 170 initiating dynamic scheduling for a secure information transmission. The BS 170 may transmit (step 1402) DCI to the UE 110. The DCI may include an indication of what information, such as positioning information, sensing information and/or AI information, etc., is to be measured and/or transmitted. Additionally or alternatively, the DCI may include a transmission grant, with the indications of the information type and an indication of a QoS characteristic. Further, the DCI may be CRC scrambled by a new RNTI that is specifically used for communication of such information such as positioning information, sensing information or/and AI information (where one or more new RNTIs can be employed for the communications) and is different from the C-RNTI already associated with the UE 110. The DCI may include at least one parameter associated with information transfer for a UL path and/or a DL path between the UE 110 and the BS 170. The DCI may include securing information, such as ciphering and integrity protection information, which can be used by the UE 110 to generate secure information. Various initiation conditions may be established for causing the BS 170 to transmit (step 1402) the DCI to initiate dynamic scheduling for a UE information transmission or sending the information to the UE. For example, the BS 170 may initiate dynamic scheduling for a UE information transmission when there is information to be sent to the UE 110. The BS 170 may initiate dynamic scheduling for a UE information transmission when scheduling a UL grant for the UE information. The BS 170 may initiate dynamic scheduling for a UE information transmission, periodically, upon request from the core network 130. The BS 170 may initiate dynamic scheduling for a UE information transmission when a timer expires. The BS 170 may initiate dynamic scheduling for a UE information transmission upon receipt of a request from any other network entity, element or node. Responsive to receiving the DCI, the UE may transmit (step 1404), in a UL data channel, the information, such as positioning information, sensing information, AI information, etc., as indicated in the DCI and configured by the BS 170. The information type for the information may be the information type indicated in the DCI. Additionally, the UE 110 may ensure the UL transmission has the QoS indicated in the DCI. The information transmitted (step 1404), by the UE 110, may be secured based on the securing information. Moreover, the BS 170 may transmit (1406), in a DL data channel, the information such as positioning information, sensing information, AI information, etc., to the UE 110, where the DL transmission (1406) may or may not be associated with the UL transmission (1404) in terms of, e.g., the transmissions being responsive to each other, and the DL transmission (1406) can be performed before the UL transmission (1404). In other embodiments, the BS 170 may initiate (dynamically or semi-statically) transmission of one or both of the DL information and the UL information (of “special data”, “sensitive data”, or “privacy data”) such as positioning information, sensing information, AI information, etc. The information transmitted (step 1406), by the BS 170, may be secured based on the securing information.

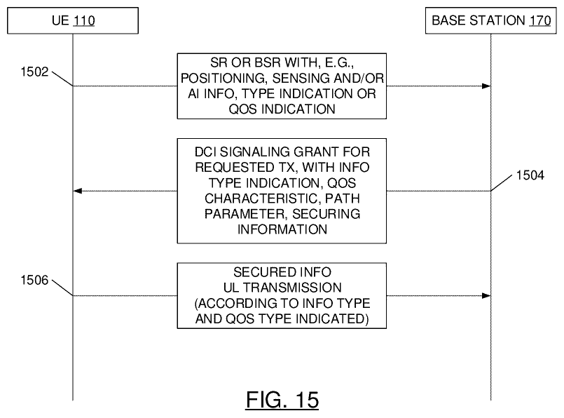

FIG. 15 illustrates, in a signal flow diagram, an exchange of messages between the BS 170 and the UE 110 in the case of the information transmission being initiated by the UE 110 requesting a transmission of information such as positioning information, sensing information, AI information, etc. The UE 110 may transmit (step 1502) a BSR or an SR. The BSR or SR transmitted in step 1502 may include an indication that the information transmission will include positioning information, sensing information and/or AI information. A BSR configuration or an SR configuration may be established ahead of time. In particular, specific or dedicated resource configurations of MAC messages may allow the UE 110 to use BSR to initiate the information transmission. Similarly, specific or dedicated resource configurations of PHY channels, such as the PUCCH, may allow the UE 110 to use SR to initiate the information transmission. The BS 170 may schedule a grant for the information transmission, as requested by the UE 110, and transmit (step 1504) DCI to the UE 110. The DCI may include the grant for the information transmission and may include an indication of an information type and a QoS characteristic. Further, the DCI may be CRC scrambled with a new RNTI that is different from the C-RNTI already associated with the UE 110. The DCI may include at least one parameter associated with information transfer for a UL path and/or a DL path between the UE 110 and the BS 170. The DCI may include securing information, such as ciphering and integrity protection information, which can be used by the UE 110 to generate secure information. After receiving the DCI, the UE may transmit (step 1506) the information as indicated in the DCI and configured by the BS 170. The information transmitted (step 1506), by the UE 110, may be secured based on the securing information. The information transfer procedure outlined in FIG. 15 may be considered to be a grant-based transmission. In other embodiments, the UE transmission resources can be (pre-)configured by RRC or can be pre-defined such that the UE 110 can transmit, in a grant-free manner, the UE information, such as positioning information, sensing information, AI information, etc., upon demand (as described in the following paragraph).

Various initiation conditions may be established for causing the UE 110 to initiate information transmission by requesting (step 1502), from the BS 170, a grant for the information transmission. For example, the initiation, by the UE 110, may be event-driven. The UE 110 may initiate information transmission when there is UL information to be provided to the BS 170. The UE 110 may initiate information transmission when there is a sudden change in terms of channel conditions, mobility, positioning information or AI information. The UE 110 may initiate information transmission responsive to receiving a request by any other network entity, element or node. For another example, the initiation, by the UE 110, may be time-driven. The UE 110 may initiate information transmission when a timer expires. The UE 110 may initiate information transmission periodically. The UE 110 may initiate information transmission semi-statically by configuration.

Upon receiving the DCI, the UE 110 may transmit (step 1506) the UE privacy information. The information type for the UE privacy information may be the information type indicated in the DCI. Additionally, the UE 110 may ensure the UL has the QoS indicated in the DCI. One or more new RNTIs may be used for the UE privacy information transmission (step 1506). The new RNTIs, which are separate and distinct from the C-RNTI already associated with the UE 110, may be flexible. Such flexibility may allow for monitoring of the PDCCH resources and scheduling cycles. The PDCCH resources and scheduling cycles may also be configurable. The new RNTIs allow for differentiation between the UE privacy information transmission and normal data traffic. Such differentiation may occur at the level of the core network 130 or at the level of an application. A new DCI format may be defined to include indications on, for example, QoS or UE information type.

It is notable that, usually, a combination of RRC and dynamic signaling configurations (e.g., L1 signaling or DCI signaling) can be applied to perform dynamic secure information transfer over DL and UL paths. Moreover, or alternatively, the BS 170 may also be configured for semi-static or periodic information transmission over UL/DL secure transfer paths, for example, via RRC configurations. These information transmissions may occur without regard to whether the information transmission is UE-sensitive or not.

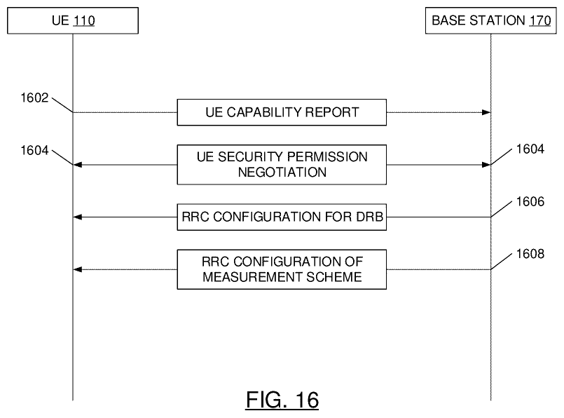

FIG. 16 illustrates, in a signal flow diagram, an exchange of messages between the BS 170 and the UE 110 ahead of the exchanges represented in FIG. 14 and FIG. 15. The signal flow diagram FIG. 16 is representative of a scenario wherein the UE 110 is in an active operational mode and has an RRC connection with the BS 170. The UE may transmit (step 1602) a report/message to the BS 170 to indicate capabilities of the UE 110. The indicated UE capabilities may be associated with a service. Example services (or operations), with which the UE capabilities may be associated include a sensing service, a positioning service, an AI service, etc. In addition to the BS 170, the indicated UE capabilities may reach the core network 130, such that a network entity (not shown) may configure the service according to the UE capabilities.

The UE 110 and the BS 170 may negotiate (step 1604) a security permission agreement between the UE 110 and the BS 170. The security permission agreement may extend to the core network 130. The security permission agreement may set a scope for the BS 170 to access service information from the UE 110 that relates to a particular service or a particular set of information or parameters, where the service/information of interest may be associated with positioning, sensing and/or AI.

Given the scope of the service information to be accessed by the BS 170, through negotiating (step 1604) with the UE 110, the BS 170 can define and configure QoS for each set of configurable service information (among possibly multiple configurable sets of service information). The BS 170 may also, through negotiating (step 1604) with the UE 110, define and configure QoS for each secure transfer path corresponding to the services in one or more sublayers, such as the SDAP sublayer or the PDCP sublayer.

The BS 170 may transmit (step 1606) an RRC configuration for the DRB and one transmission path (UL or DL path). The RRC configuration for the DRB may include a mapping between an SDAP QoS category and a DRB identification (DRB ID). The RRC configuration for the DRB may include a mapping between a DRB ID and a logical channel identification (LCID). The RRC configuration for the DRB may include information type associated with a DRB ID. The RRC configuration for the DRB may include an information format associated with a DRB ID.

The BS 170 may transmit (step 1608) an RRC configuration for a measurement procedure for the UE 110 to carry out specific measurements. The RRC configuration for the measurement procedure may include parameters. The parameters may include resources for semi-static information transfer. The parameters may include resources for periodic information transfer. The parameters may include resources for grant-free (GF) information transfer. The parameters may include resources for BSR/SR. Optionally, responsive to receiving the RRC configuration for the measurement procedure, the UE 110 may carry out the associated measurement, as configured. Optionally, responsive to receiving the RRC configuration for the measurement procedure, the UE 110 may perform semi-static information transfer, periodic information transfer or GF information transfer.

In accordance with aspects of the present application, the BS 170 may define and configure UL secure transfer paths without QoS capability between the UE 110 and the BS 170. In this case, each PDU session may be mapped to one DRB, since all traffic flows have the same QoS nature. There are at least two ways of accomplishing the mapping of PDU sessions to a single DRB: the BS 170 may use an SDAP PDU format with an SDAP header; or the BS 170 may use an SDAP PDU format without an SDAP header.

When using an SDAP PDU format with an SDAP header, the QFI field of the SDAP header may be configured with some specific value for all flows. Accordingly, it may be successfully represented that there are no QoS differentiations among the various UE information types. Note that it is possible that different types of UE information (and the related PDU session) may be mapped to the same DRB or mapped to different DRBs. As discussed hereinbefore, the different types of UE information may include the sensing information type, the positioning information type or the AI information type. The C field in the SDAP header may be configured in same way as the C field is configured for the case wherein the QoS capability is configured. For example, the C field may be configured to identify the UE information (list) to be transmitted or reported.

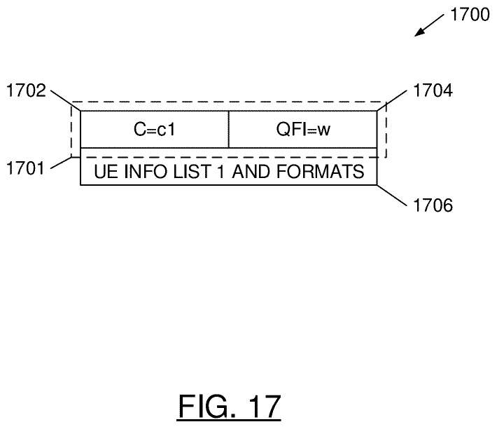

FIG. 17 illustrates a new SDAP message 1700 carrying secure information. The new SDAP message 1700 may carry the UE information such as non-latency-critical positioning information in a way defined or configured by UE INFO LIST 1 AND FORMATS, where the UE INFO LIST 1 AND FORMATS can be configured by RRC pre-configured or predefined. The new SDAP message 1700 of FIG. 17 includes an SDAP header 1701. The SDAP header 1701 includes a C field 1702. The new SDAP header 1701 of FIG. 17 also includes a QFI field 1704 for SDAP message/flow QoS indication. As discussed hereinbefore, the QFI field 1704 of the SDAP header 1701 may be configured with the same specific value for all flows. The QFI field 1704 of the new SDAP header 1701 of FIG. 17 may carry a value, e.g., “w,” that specifies a non-QoS attribute. The new SDAP message 1700 of FIG. 17 includes an SDAP message body field 1706. For example, the SDAP message body field 1706 of the new SDAP message 1700 of FIG. 17 includes a UE INFO LIST 1 and FORMATS.

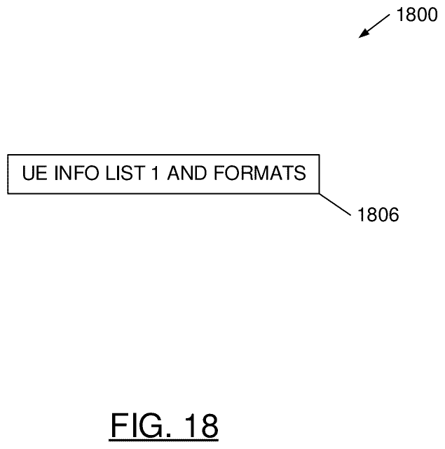

When using an SDAP PDU format without an SDAP header (see FIG. 18), the SDAP messages are purely the UE information, without any QoS differentiations among the traffic flows. Note that it is possible that different types of UE information (and the corresponding PDU session) may be mapped to the same DRB or mapped to different DRBs. As discussed hereinbefore, the different types of UE information may include the sensing information type, the positioning information type or the AI information type. In this case, there is no C field (since there is no SDAP header) to identify the UE information (list) to be transmitted or reported. Furthermore, the UE information (e.g., the positioning information) may not be categorized into different lists.

FIG. 18 illustrates a new SDAP message 1800 carrying secure information. The new SDAP message 1800 of FIG. 18 does not include an SDAP header. The new SDAP message 1800 of FIG. 18 includes an SDAP message body field 1806. For example, the SDAP message body field 1806 of the new SDAP message 1800 of FIG. 18 includes a UE INFO LIST 1 and FORMATS.

As discussed in the context of the signal flow illustrated in FIG. 16, the BS 170 may transmit (step 1606) an RRC configuration for the DRB. The RRC configuration may include report information (UE INFO LIST), information types and information formats for secure transfer UL paths, where UL flows can be mapped to DRBs and to MAC logical identities. One PDU session with an SDAP header may map different flows to one or more DRBs. One PDU session without an SDAP header may map different flows to one DRB.

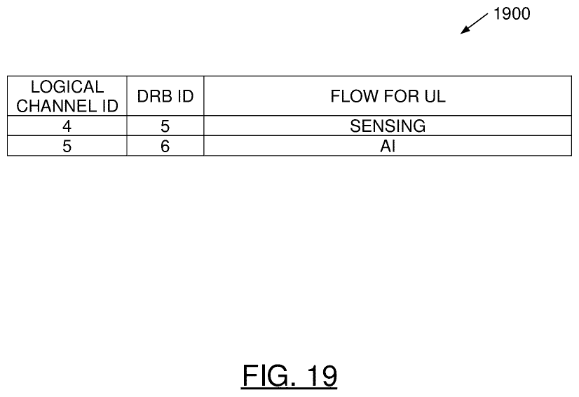

A UL traffic flow mapping configuration 1900 is illustrated in FIG. 19, where traffic flow(s) or the UE information type/context configured with an QFI for a UL path may be associated with dedicated radio bearer with a DRB identity and the DRB identity is mapped to a LCID, where a different LCID may be associated with a different transmission priority that is associated with the UE information. As a result, to configure and establish UL paths according to the UL traffic flow mapping configuration 1900 in FIG. 19: information/traffic flow with type “sensing” is associated with a DRB ID of 5, which is configured and mapped to an LCID of 4; and information/traffic flow with type “AI” is associated with a DRB ID of 6, which is configured and mapped to an LCID of 5. Note that DRB ID values and LCID values in FIG. 19 are only examples and other values can be applicable as well.

Conveniently, this transfer allows for transfer of both time-sensitive sensitive UE information and non-time-critical sensitive UE information. Furthermore, This transfer allows for transfer of both short amounts of information and large amounts of information.

Positioning information carried in the new SDAP message 1800 of FIG. 18 may follow the secure UL path 600 illustrated in FIG. 6.

The SDAP message may be encrypted in the PDCP sublayer and may pass through processing in the RLC sublayer, the MAC sublayer and the PHY sublayer to, thereby, form transmitted signals at the UE 110 end of an over-the-air link to the BS 170 end.

The signals received at the BS 170 may go through inverse signal processing from the PHY sublayer up to the SDAP sublayer so that the BS 170 may obtain the positioning information. The positioning information may be used, by the BS 170, for communication control and management, including (dynamic) beam switching and management and optimized scheduling.

As discussed hereinbefore, although the secure UL path 600 is discussed as being configured for secure information transmission by the UE 110, it is also possible that the secure UL path 600 may also be used for transmission of non-sensitive information.

According to aspects of the present application, the BS 170 may define and configure secure DL transfer paths without QoS capability between the UE 110 and the BS 170.

In this case, each PDU session may be mapped to one DRB, since all of the traffic flows associated with the PDU session have the same QoS nature. There are at least two ways of accomplishing the mapping of PDU sessions to a single DRB: the BS 170 may use an SDAP PDU format with an SDAP header; or the BS 170 may use an SDAP PDU format without an SDAP header.

When using an SDAP PDU format with an SDAP header, the QFI field of the SDAP header may be configured with some specific value for all flows.

Accordingly, it may be successfully represented that there are no QoS differentiations among the various UE information types. Note that it is possible that different type of UE information (and its PDU session) may be mapped to the same DRB or mapped to different DRBs. As discussed hereinbefore, the different types of UE information may include the sensing information type, the positioning information type or the AI information type. The C field in the SDAP header may be configured in same way as the C field is configured for the case wherein the QoS capability is configured. For example, the C field may be configured to identify the UE information (list) to be transmitted or reported.

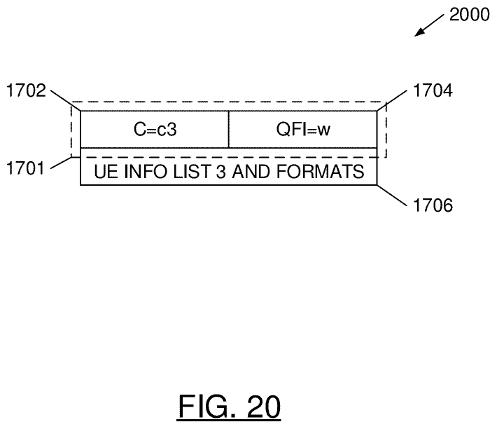

FIG. 20 illustrates a new SDAP message 2000 carrying secure information. The new SDAP message 2000 of FIG. 20 includes the SDAP header 1701. The SDAP header 1701 includes the C field 1702. The new SDAP header 1701 of FIG. 20 also includes the QFI field 1704 for SDAP message/flow QoS indication. As discussed hereinbefore, the QFI field 1704 of the SDAP header 1701 may be configured with the same specific value for all flows. The QFI field 1704 of the new SDAP header 1701 of FIG. 20 may carry a value, e.g., “w,” that specifies a non-QoS attribute. The new SDAP message 2000 of FIG. 20 includes an SDAP message body field 1706. For example, the SDAP message body field 1706 of the new SDAP message 2000 of FIG. 20 includes a UE INFO LIST 3 and FORMATS.

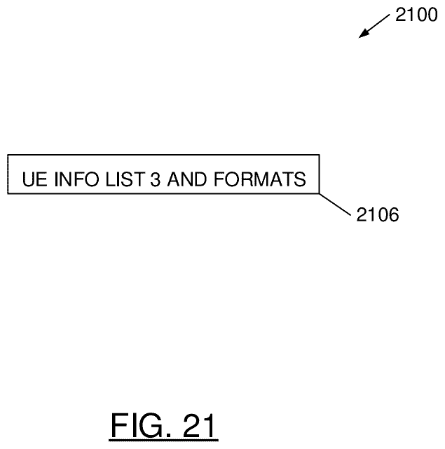

When using an SDAP PDU format without an SDAP header (see FIG. 21), the SDAP messages are purely the UE information, without any QoS differentiations among the traffic flows. Note that it is possible that different types of UE information (and the corresponding PDU session) may be mapped to the same DRB or mapped to different DRBs. As discussed hereinbefore, the different types of UE information may include the sensing information type, the positioning information type or the AI information type. In this case, there is no C field (since there is no SDAP header) to identify the UE information (list) to be transmitted or reported. Furthermore, the UE information (e.g., the positioning information) may not be categorized into different lists.

FIG. 21 illustrates a new SDAP message 2100 carrying secure information. The new SDAP message 2100 of FIG. 21 does not include an SDAP header. The new SDAP message 2100 of FIG. 21 includes an SDAP message body field 2106. For example, the SDAP message body field 2106 of the new SDAP message 2100 of FIG. 21 includes a UE INFO LIST 3 and FORMATS.

As discussed in the context of the signal flow illustrated in FIG. 16, the BS 170 may transmit (step 1606) an RRC configuration for the DRB. The RRC configuration may include report information (UE INFO LIST), information types and information formats for secure transfer DL paths, where DL flows can be mapped to DRBs and to MAC logical identities. One PDU session with an SDAP header may map different flows to one or more DRBs. One PDU session without an SDAP header may map different flows to one DRB.

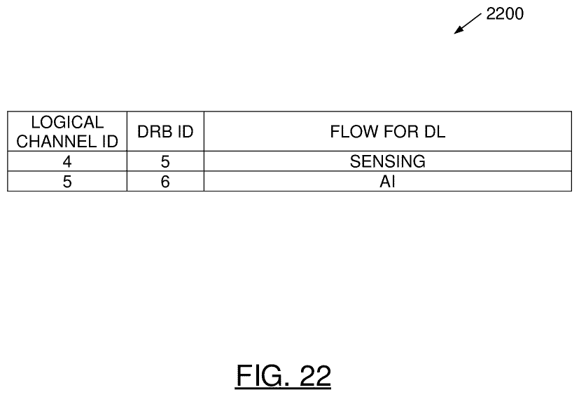

A DL traffic flow mapping configuration 2200 is illustrated in FIG. 22, where traffic flow(s) or the UE information type/context configured with an QFI for a DL path may be associated with dedicated radio bearer with a DRB identity and the DRB identity is mapped to a LCID, where a different LCID may be associated with a different transmission priority that is associated with the UE information. As a result, to configure and establish DL paths according to the DL traffic flow mapping configuration 2200 in FIG. 22: information/traffic flow with type “sensing” is associated with a DRB ID of 5, which is configured and mapped to an LCID of 4; and information/traffic flow with type “AI” is associated with a DRB ID of 6, which is configured and mapped to an LCID of 5. Note that DRB ID values and LCID values in FIG. 22 are only examples and other values can be applicable as well.

Conveniently, this transfer allows for transfer of both time-sensitive sensitive UE information and non-time-critical sensitive UE information. Furthermore, This transfer allows for transfer of both short amounts of information and large amounts of information.

Positioning information carried in the new SDAP message 2100 of FIG. 21 may follow the secure DL path 1000 illustrated in FIG. 10.

In the example shown in FIG. 10, AI (modeling) information originating at the BS 170 end is carried, over the secure DL path 1000, in an SDAP message (see the example new SDAP message 2100 of FIG. 21) using transmission formats as configured in the SDAP message body field 2106.

The SDAP message may be encrypted in the PDCP sublayer and may pass through processing in the RLC sublayer, the MAC sublayer and the PHY sublayer to, thereby, form transmitted signals at the BS 170 end of an over-the-air link to the UE 110 end.

The signals received at the UE 110 may go through inverse signal processing from the PHY sublayer up to the SDAP sublayer so that the UE 110 may obtain the AI (modeling) information.

The AI (modeling) information may be used, by the UE 110, for communication control and management, including (dynamic) AI modeling parameter updating and management, and optimized training.

Note that, though the secure DL path 1000 is configured for secure information transmission by the BS 170, it is also possible that the secure DL path 1000 may also be used for transmission of non-sensitive information. The SDAP message format may be established by RRC signaling in a control plane via SRB first; then, an SDAP message, to be organized in a form configured by the RRC, may be transferred in a user plane or via DRB, where UE secure information is transmitted. Moreover, the RRC signaling may comprise configurations of one or more of the following: DRB identity; logical channel identity associated with DRB identity; and securing information, such as UE traffic cyphering and integrity protection in one or more of PDCP, RLC, MAC, PHY sublayers in future networks.

According to aspects of the present application, the BS 170 may define and configure UL secure transfer paths without QoS capability between the UE 110 and the BS 170.

In this case, each PDU session may be mapped to one Signaling radio bearer (SRB), since all traffic flows associated with a respective PDU session have the same QoS nature. There are at least two ways of accomplishing the mapping of PDU sessions to a single SRB: the BS 170 may use an RRC message with a header; or the BS 170 may use an use an RRC message without a header.

Using an RRC message with a header may be seen as similar to using an SDAP PDU format with an SDAP header. When using an RRC message with a header to carry UE information, the QFI field of the header may be configured with some specific value for all flows. Accordingly, it may be successfully represented that there are no QoS differentiations among the various UE information types. Note that it is possible that different types of UE information (and the related PDU session over RRC message) may be mapped to the same SRB or mapped to different SRBs. As discussed hereinbefore, the different types of UE information may include the sensing information type, the positioning information type or the AI information type. The C field in the header could be configured, for example, to identify the UE information (list) to be transmitted or reported.

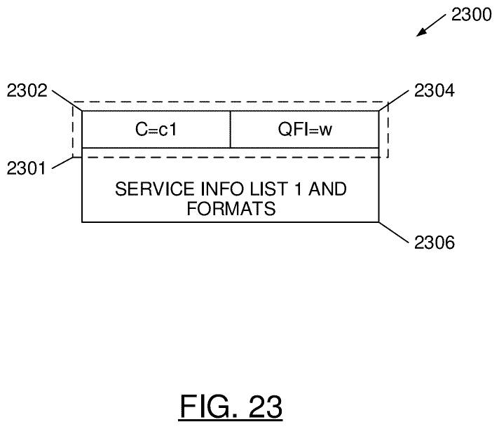

FIG. 23 illustrates a new RRC message 2300 carrying service information. The new RRC message 2300 may carry the UE information such as non-latency-critical positioning information in a way defined or configured by UE INFO LIST 1 AND FORMATS, where the UE INFO LIST 1 AND FORMATS can be configured by RRC pre-configured or predefined. The new RRC message 2300 of FIG. 23 includes a header 2301. The header 2301 includes a C field 2302. The new header 2301 of FIG. 23 also includes a QFI field 2304 for RRC message/flow QoS indication. As discussed hereinbefore, the QFI field 2304 of the RRC header 2301 may be configured with the same specific value for all flows. The QFI field 2304 of the new RRC header 2301 of FIG. 23 may carry a value, e.g., “w,” that specifies a non-QoS attribute. The new RRC message 2300 of FIG. 23 includes an RRC message body field 2306. For example, the RRC message body field 2306 of the new RRC message 2300 of FIG. 23 includes a service INFO LIST 1 and FORMATS.

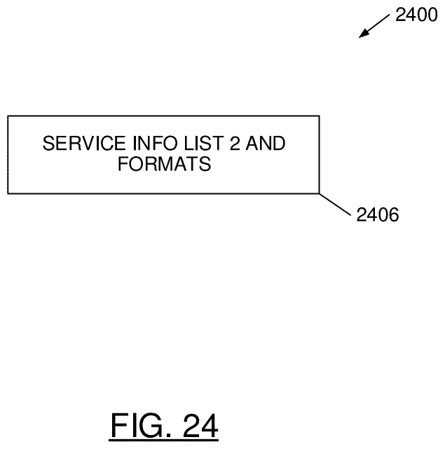

When using an RRC message without any header (see FIG. 24), the RRC message carries raw PDU session information, without additional info such as QoS differentiations among its traffic flows. Note that it is possible that different types of UE information (and the related PDU session) may be mapped to same SRB or mapped to different SRBs. As discussed hereinbefore, the different types of UE information may include the sensing information type, the positioning information type or the AI information type. In this case, there is no C field (since there is no header) to identify the UE information (list) to be transmitted or reported. It follows that the UE information (e.g., positioning information) may not be categorized into different lists.

FIG. 24 illustrates a new RRC message 2400 carrying service information. The new RRC message 2400 of FIG. 24 does not include a header. The new RRC message 2400 of FIG. 24 includes an RRC message body field 2406. For example, the RRC message body field 2406 of the new RRC message 2400 of FIG. 24 includes a service INFO LIST 2 and FORMATS.

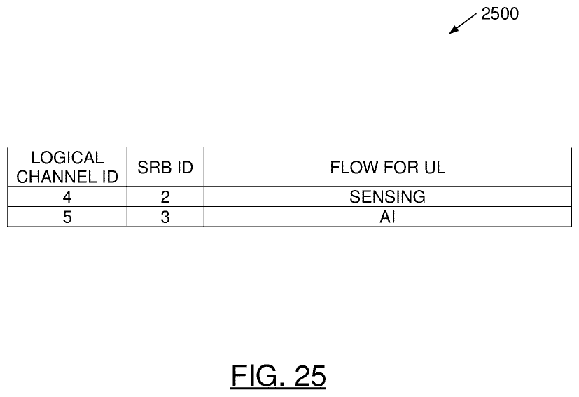

A UL traffic flow mapping configuration 2500 is illustrated in FIG. 25, where traffic flow(s) or the UE information type/context configured with an QFI for a UL path may be associated with dedicated radio bearer with an SRB identity and the SRB identity is mapped to a LCID, where a different LCID may be associated with a different transmission priority that is associated with the UE information. As a result, to configure and establish UL paths according to the UL traffic flow mapping configuration 2500 in FIG. 25: information/traffic flow with type “sensing” is associated with an SRB ID of 2, which is configured and mapped to an LCID of 4; and information/traffic flow with type “AI” is associated with an SRB ID of 3, which is configured and mapped to an LCID of 5. Note that SRB ID values and LCID values in FIG. 25 are only examples and other values can be applicable as well.

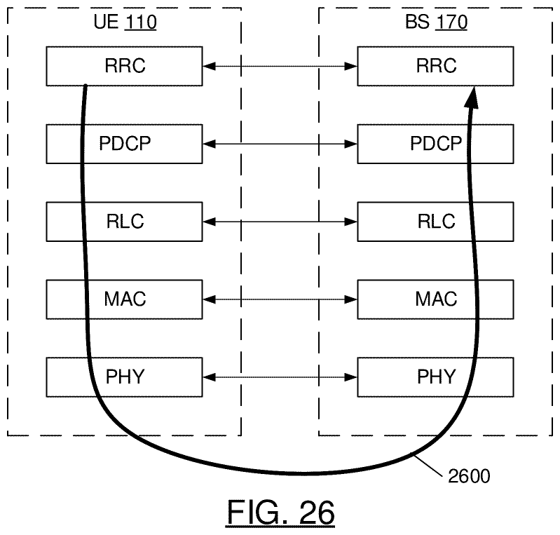

FIG. 26 illustrates communication between a UE 110 and a BS 170 over an air-link interface, also called a “Uu-link.” The UE 110 is illustrated as including many protocol sublayers defined for the over the air-link interface, identified as: RRC; PDCP; RLC; MAC; and PHY. Similarly, the BS 170 is illustrated as including many protocol sublayers defined for the over the air-link interface, identified as: RRC; PDCP; RLC; MAC; and PHY. A secure UL path 2600 with QoS is illustrated traversing the protocol sublayers from the RRC sublayer of the UE 110 to the RRC sublayer of the BS 170. The RRC sublayer may be configured for transparent transmission.

For the secure UL path 2600 of FIG. 26, UE positioning information at the UE 110 end is carried in an RRC message using the transmission formats as configured. The RRC message may be encrypted in the PDCP sublayer and may pass through processing in the RLC sublayer, the MAC sublayer and the PHY sublayer to, thereby, form transmitted signals at the UE 110 end of an over-the-air link to the BS 170 end.

The signals received at the BS 170 may go through inverse signal processing from the PHY sublayer up to the RRC sublayer so that the BS 170 may obtain the positioning information. The positioning information may be used, by the BS 170, for communication control and management, including (dynamic) beam switching and management and optimized scheduling.

Note that, though the secure UL path 2600 may be configured, with parameters provided by the BS 170, for secure information transmission by the UE 110, it is also possible that the secure UL path 2600 may be used for transmission of non-sensitive information. The RRC message format and the QoS configurations may be established by RRC signaling in a control plane via SRB first; then, an RRC message, to be organized in a form configured by the RRC, may be transferred in a user plane or via SRB, where UE secure information is transmitted. Moreover, the RRC signaling may comprise configurations of one or more of the following: traffic QoS for the information (to be transmitted as SDAP message); SRB identity; logical channel identity associated with SRB identity; and securing information, such as UE traffic cyphering and integrity protection in one or more of PDCP, RLC, MAC, PHY sublayers in future networks.

According to aspects of the present application, the BS 170 may define and configure DL secure transfer paths without QoS capability between the BS 170 and the UE 110.

In this case, each PDU session may be mapped to one SRB, since all traffic flows associated with a respective PDU session have the same QoS nature. There are at least two ways of accomplishing the mapping of PDU sessions to a single SRB: the BS 170 may use an RRC message with a header; or the BS 170 may use an use an RRC message without a header.

Using an RRC message with a header may be seen as similar to using an SDAP PDU format with an SDAP header. When using an RRC message with a header to carry UE information, the QFI field of the header may be configured with some specific value for all flows. Accordingly, it may be successfully represented that there are no QoS differentiations among the various UE information types. Note that it is possible that different types of UE information (and the related PDU session over RRC message) may be mapped to the same SRB or mapped to different SRBs. As discussed hereinbefore, the different types of UE information may include the sensing information type, the positioning information type or the AI information type. The C field in the header could be configured, for example, to identify the UE information (list) to be transmitted or reported.

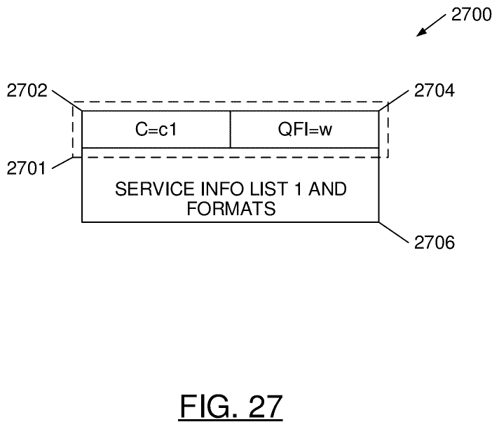

FIG. 27 illustrates a new RRC message 2700 carrying service information. The new SDAP message 1200 may carry the UE information such as non-latency-critical positioning information in a way defined or configured by UE INFO LIST 1 AND FORMATS, where the UE INFO LIST 1 AND FORMATS can be configured by RRC pre-configured or predefined. The new RRC message 2700 of FIG. 27 includes a header 2701. The header 2701 includes a C field 2702. The new header 2701 of FIG. 27 also includes a QFI field 2704 for RRC message/flow QoS indication. As discussed hereinbefore, the QFI field 2704 of the RRC header 2701 may be configured with the same specific value for all flows. The QFI field 2704 of the new RRC header 2701 of FIG. 27 may carry a value, e.g., “w,” that specifies a non-QoS attribute. The new RRC message 2700 of FIG. 27 includes an RRC message body field 2706. For example, the RRC message body field 2706 of the new RRC message 2700 of FIG. 27 includes a service info list and formats.

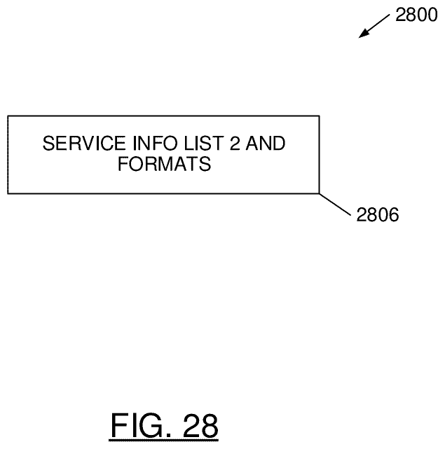

Using an RRC message without a header (see FIG. 28) may be seen as similar to using an SDAP PDU format without an SDAP header. An RRC message without a header carries raw PDU session information without additional info such as QoS differentiations among traffic flows. Note that it is possible that different types of UE information (and the related PDU session over RRC message) may be mapped to the same SRB or mapped to different SRBs. As discussed hereinbefore, the different types of UE information may include the sensing information type, the positioning information type or the AI information type. In this case, there is no C field (as there is no header) to identify the UE information (list) to be transmitted or reported. It follows that the UE information (e.g., positioning information) may not be categorized into different lists.

FIG. 28 illustrates a new RRC message 2800 carrying service information. The new RRC message 2800 of FIG. 28 does not include a header. The new RRC message 2800 of FIG. 28 includes an RRC message body field 2806. For example, the RRC message body field 2806 of the new RRC message 2800 of FIG. 28 includes a service INFO LIST 2 and FORMATS.

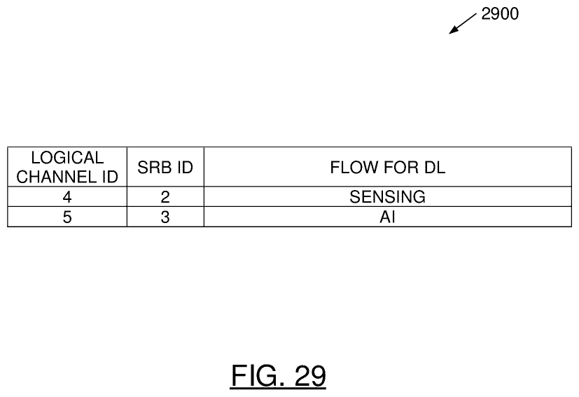

A DL traffic flow mapping configuration 2900 is illustrated in FIG. 29, where traffic flow(s) or the UE information type/context configured with an QFI for a DL path may be associated with dedicated radio bearer with an SRB identity and the SRB identity is mapped to a LCID, where a different LCID may be associated with a different transmission priority that is associated with the UE information. As a result, to configure and establish DL paths according to the DL traffic flow mapping configuration 2900 in FIG. 29: information/traffic flow with type “sensing” is associated with an SRB ID of 2, which is configured and mapped to an LCID of 4; and information/traffic flow with type “AI” is associated with an SRB ID of 3, which is configured and mapped to an LCID of 5. Note that SRB ID values and LCID values in FIG. 29 are only examples and other values can be applicable as well.

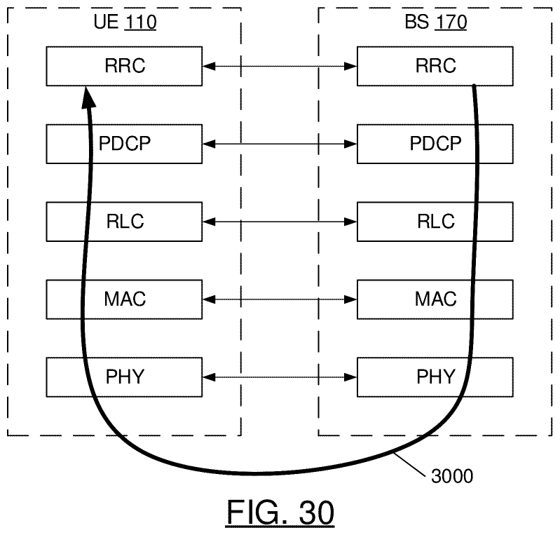

FIG. 30 illustrates communication between a UE 110 and a BS 170 over an air-link interface, also called a “Uu-link.” The UE 110 is illustrated as including many protocol sublayers defined for the over the air-link interface, identified as: RRC; PDCP; RLC; MAC; and PHY. Similarly, the BS 170 is illustrated as including many protocol sublayers defined for the over the air-link interface, identified as: RRC; PDCP; RLC; MAC; and PHY. A secure DL path 3000 with QoS is illustrated traversing the protocol sublayers from the RRC sublayer of the BS 170 to the RRC sublayer of the UE 110. The RRC sublayer may be configured for transparent transmission.

For the secure DL path 3000 of FIG. 30, AI (modeling) information originating at the BS 170 end is carried in an RRC message using the transmission formats as configured. The RRC message may be encrypted in the PDCP sublayer and may pass through processing in the RLC sublayer, the MAC sublayer and the PHY sublayer to, thereby, form transmitted signals at the BS 170 end of an over-the-air link to the UE 110 end.

The signals received at the UE 110 may go through inverse signal processing from the PHY sublayer up to the RRC sublayer so that the UE 110 may obtain the AI (modeling) information. The AI (modeling) information may be used, by the UE 110, for communication control and management, AI modeling parameter updating and management, and optimized training.

Note that, though the secure DL path 3000 may be configured, with parameters established at the BS 170, for secure information transmission by the BS 170, it is also possible that the secure DL path 3000 may be used for transmission of non-sensitive information. The RRC message format and the QoS configurations may be established by RRC signaling in a control plane via SRB first; then, an RRC message, to be organized in a form configured by the RRC, may be transferred in a user plane or via SRB, where UE secure information is transmitted. Moreover, the RRC signaling may comprise configurations of one or more of the following: traffic QoS for the information (to be transmitted as SDAP message); SRB identity; logical channel identity associated with SRB identity; and securing information, such as UE traffic cyphering and integrity protection in one or more of PDCP, RLC, MAC, PHY sublayers in future networks.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method of communicating information, the method comprising:
receiving, by an apparatus from a network device, one or more configuration, the one or more configuration comprises:
at least one traffic Quality of Service (QoS) characteristic defined by the network device;
at least one parameter associated with information transfer for an uplink (UL) path and a downlink (DL) path between the apparatus and the network device; and
securing information;
transmitting information, using the UL path, by the apparatus to the network device or receiving information, using the DL path, by the apparatus from the network, wherein the information is secured based on the securing information.

2. The method of claim 1, wherein the information has an information type.

3. The method of claim 2, wherein the information type comprises at least one of the following:
positioning information;
sensing information; and
artificial intelligence information.

4. The method of claim 1, the method further comprising, before the receiving the one or more configuration, transmitting, by the apparatus to the network device, a capability report.

5. The method of claim 1, wherein the one or more configuration further comprises an indication of a measurement scheme and the method further comprises performing measurement according to the measurement scheme.

6. The method of claim 1, wherein the transmitting the information comprises transmitting measurement information.

7. The method of claim 1, wherein the securing information comprises ciphering and integrity protection information for generating secure information, wherein the secure information is generated in one or more of:
a packet data convergence protocol (PDCP) layer;
a radio link control (RLC) protocol layer;
a media access control (MAC) protocol layer;
a physical (PHY) protocol layer;
a radio frequency (RF) chain; and
a specially encoded and encrypted context.

8. The method of claim 1, wherein the transmitting information or the receiving information comprises transmitting or receiving a service data adaptation protocol (SDAP) message.

9. The method of claim 8, wherein the SDAP message comprises an SDAP header.

10. The method of claim 9, wherein the transmitting information or the receiving information further comprises indicating the traffic QoS characteristic in the SDAP header.

11. The method of claim 9, wherein the transmitting information or the receiving information further comprises indicating a message category in the SDAP header.

12. The method of claim 1, wherein the one or more configuration is received in a radio resource control (RRC) message.

13. The method of claim 12, wherein the RRC message comprises an indication of the traffic QoS characteristic for a plurality of traffic flows in a protocol data unit (PDU) session.

14. The method of claim 13, wherein each traffic flow among the plurality of traffic flows in the PDU session is configured with a respective traffic QoS characteristic.

15. The method of claim 13, wherein the traffic QoS characteristic defined by the network device comprises a mapping of the QoS characteristic to a traffic flow among the plurality of traffic flows in the PDU session.

16. An apparatus comprising:
a memory storing instructions;
a processor caused, by executing the instructions, to:
receive, from a network device, one or more configuration, the one or more configuration including:
at least one traffic Quality of Service (QoS) characteristic defined by the network device;
at least one parameter associated with information transfer for an uplink (UL) path and a downlink (DL) path between the apparatus and the network device; and
securing information;
transmit information, using the UL path, by the apparatus to the network device or receiving information, using the DL path, by the apparatus from the network, wherein the information is secured based on the securing information.

17. The apparatus of claim 16, wherein the information has an information type.

18. The apparatus of claim 17, wherein the information type comprises at least one of the following:
positioning information;
sensing information; and
artificial intelligence information.

19. The apparatus of claim 16, the processor further caused to, before being caused to receive the one or more configuration, transmit, to the network device, a capability report.

20. A method of communicating information, the method comprising:
transmitting, by a network device to an apparatus, one or more configuration, the one or more configuration comprises:
at least one traffic Quality of Service (QoS) characteristic defined by the network device;
at least one parameter associating with information transfer for an uplink (UL) path and a downlink (DL) path between the apparatus and the network device; and
securing information;
receiving information using the UL path, by the network device from the apparatus, or transmitting information using the DL path, by the network device to the apparatus, wherein the information is secured based on the securing information.
